(19) United States
(12) Patent Application Publication
(10) Pub. No.: US 2008/0092179 A1
(43) Pub. Date: Apr. 17, 2008

(54) MULTIFUNCTIONAL MOBILE COMMUNICATION DEVICE

(75) Inventors: CHIOU-LIN FAN, Tu-Cheng (TW); CHIN-FENG CHEN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/614,724

(22) Filed: Dec. 21, 2006

(30) Foreign Application Priority Data
Oct. 13, 2006 (CN) 200610063085.3

(51) Int. Cl. H04N 5/44; H04N 7/16

(52) U.S. Cl. 725/62; 725/135; 348/734

(57) ABSTRACT

A multifunctional mobile communication device includes a main body (10) provided with a screen (102), at least one keypad, a main board (12), a TV button (221), a screen button (223), one ore more ports (241) and an antenna. The main board is electronically connected with a display module (14), an operating module (16), and an audio input/output module (18), a power module (20), a switching module (22) and TV module (24). The screen is controlled by the display module. The keypad is electronically connected with the operating module. The TV button and the screen button both are electronically connected with the switching module and the TV module. The antenna and the one or more ports both are connected with the TV module.

### BACKGROUND OF THE INVENTION

1. Field of the Invention

The present invention generally relates to multifunctional mobile communication devices and more particularly to a multifunctional mobile communication device that can be used for receiving and instantaneously displaying television (TV) signals as well as for mobile communication.

2. Description of Related Art

Nowadays the integration of mobile technology and multimedia is a developing technical trend. However, traditional television apparatuses are bulky and are therefore difficult to integrate into portable devices such as mobile phones.

Accordingly, what is needed is a multifunctional mobile communication device capable of receiving and instantaneously displaying television (TV) signals as well as mobile communication.

### SUMMARY

A multifunctional mobile communication device includes a main body provided with a screen, at least one keypad, a main board, a TV button, a screen button, one or more ports and an antenna. The main board is electronically connected with a display module, an operating module, an audio input/output module, a power module, a switching module, and TV module. The screen is controlled by the display module and is used for processing and outputting video signal. The keypad is electronically connected with the operating module for controlling operation or data input. The TV button and the screen button are electronically connected with the switching module and the TV module for activating/deactivating the device mode and the TV operating surface. The antenna and the one or more ports are connected with the TV module for receiving and transmitting signals. The power module is used for powering the display module, the operating module and the audio input/output module.

As a further improvement of the present invention, the multifunctional mobile communication device integrates a common mobile communication device with the ability to receive and instantaneously display television (TV) signals.

Other advantages and novel features will become more apparent from the following detailed description when taken in conjunction with the accompanying drawings.

### BRIEF DESCRIPTION OF THE DRAWINGS

Many aspects of the multifunctional mobile communication device can be better understood with reference to the following drawings. The components in the drawings are not necessarily drawn to scale, the emphasis instead being placed upon clearly illustrating the principles of the present functional mobile communication device. Moreover, in the drawings, like reference numerals designate corresponding parts throughout the several views.

FIG. 1 is a block diagram of a multifunctional mobile communication device of a preferred embodiment; and

FIG. 2 is a perspective view of the multifunctional mobile communication device of the preferred embodiment.

### DETAILED DESCRIPTION OF THE INVENTION

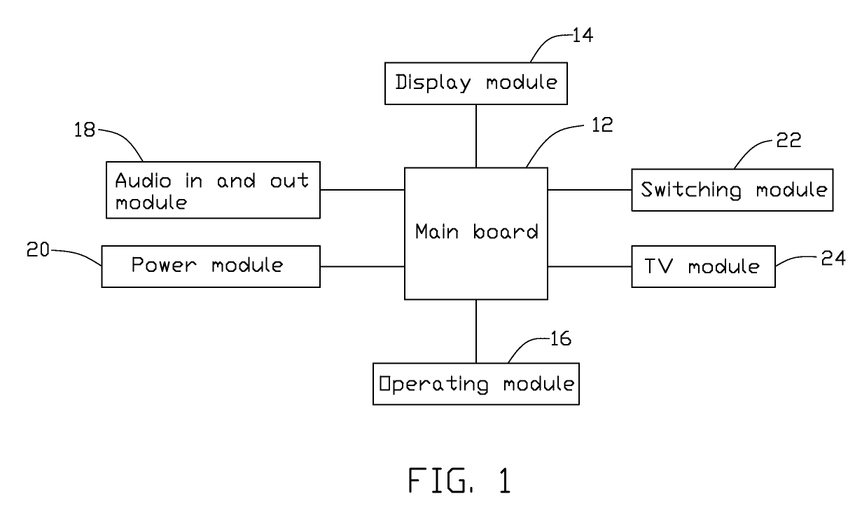

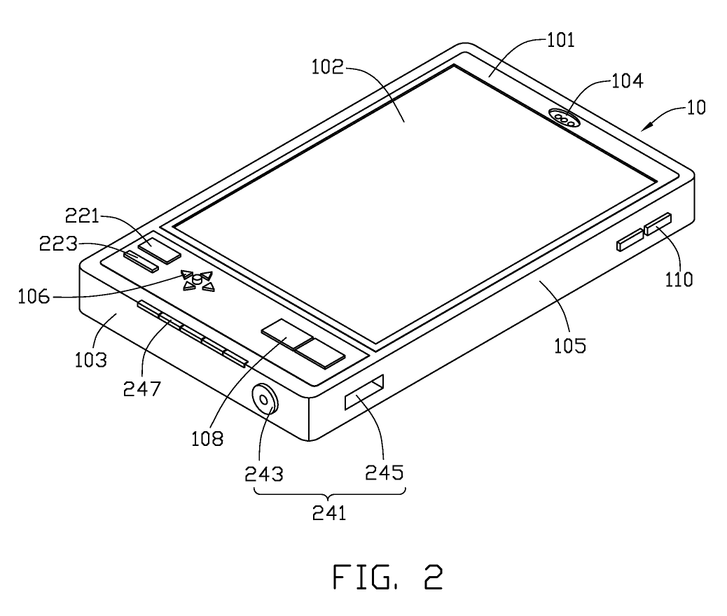

Referring to FIG. 1 and FIG. 2, in a preferred embodiment, a multifunctional mobile communication device is a multifunctional mobile phone. The multifunctional mobile communication device includes a main body 10 and a remote control device (not shown).

The main body 10 is a similar parallelepiped which includes a first surface 101, a second surface 103 and a side surface 105. A main board 12, a display module 14, an operating module 16, and an audio input/output module 18, a power module 20, a switching module 22, and a TV (television) module 24 are provided inside the main body 10. The main board 12 is for connecting each module and processing the related data. The display module 14 is for processing and outputting video signals. The operating module 16 is for controlling operation or inputting operation of characters and data. The audio input/output module 18 is for inputting or outputting audio signal of TV and mobile communication. The power module 20 can be a battery, and is for powering the modules. The switching module 22 is for controlling the TV module 24. The TV module 24 is for receiving and processing television signals. The display module 14, the operating module 16, the audio input/output module 18, the power module 20, the switching module 22, and the TV module 24 are electronically connected with the main board 12 respectively through USB (universal serial bus).

The main body 10 has functions and elements for a common mobile phone, such as a screen 102, at least one keypad (not labeled) and a telephone receiver 104. Furthermore, the main body 10 can include a TV button 221, a screen button 223, one or more ports 241, a TV signal detection area 247, and an antenna (not shown). In the embodiment, the screen 102 can be located on the first surface 101 of the main body 10. The screen 102 can be a touch panel, thus allowing the omission of an additional keypad. The telephone receiver 104 can be located near one end of the screen 102 on the first surface 101 of the main body 10. The at least one keypad can include a direction key 106, an on-off key 108, and a volume key 110. The direction key 106 is used for selecting the needed functions on the screen 102. The on-off key 108 can be used for connecting/disconnecting incoming/outgoing calls. The volume key 110 can be used for controlling the volume. The direction key 106 and on-off key 108 are located side by side near the other end of the screen 102 in the first surface 101 of the main body 10. The volume key 110 can be located on the side surface 105 of the main body 10.

The TV button 221 and the screen button 223 are located side by side on the first surface 101 of the main body 10, and in the same side of the direction key 106 away from the on-off key 108. By pressing the TV button 221, the device can be switched into a TV mode or a phone mode, and the TV operating surface also can be switched. By pressing the screen button 223, the TV playing screen can be switched into another display device, such as a mobile phone, a computer, a notebook and another device.

The ports 241 include a cable port 243 and a USB port 245 located on the second surface 103 and the side surface 105 of the main body 10 respectively. The cable port 243 can be used for transmitting TV signals. The USB port 245 can be used for transmitting signals and powering the power module 20.

The TV signal detection area 247 is located at a joint of the first surface 101 and the second surface 103 of the main body 10. The TV signal detection area 247 includes a plurality of indicator lights for showing the strength of the TV signal. The antenna is located inside the main body 10 and can be used for receiving TV signals and receiving and transmitting radio signals. Of course, the antenna can also be located outside the main body 10 or can be a telescopic antenna.

The screen 102 can be controlled by the display module 14 and can be used for displaying the video signal. The keypad is electronically connected with the operating module 16 for controlling and data input. The TV button 221 and the screen button 223 are both electronically connected with the switching module 22 and the TV module 24. The ports 241, the TV signal detection area 247, and the antenna are all connected with the TV module 24. A remote control device such as a infrared remote control device can be provided for remote controlling of the TV module 24.

In use, when the multifunctional mobile phone is in phone mode and TV mode is needed, the mode can be switched to TV mode by pressing the TV button 221. The antenna located inside the main body 10 receives the TV signal. The keypad or the remote control device is used for switching the TV channels. If, according to the signal strength shown in the TV signal detection area 247, additional signal strength is needed, a cable transmitting the TV signal from a cable TV service provider or from an external aerial can be inserted into the cable port 243. The TV program can be switched to play on a computer or similar device by pressing the screen button 223 and connecting the USB port 245 to the main body 10 with a computer or another device.

It should be understood that the screen 102 can be a common LCD (liquid crystal display) instead of a touch panel, and an additional keypad can be provided in the main body 10. The TV signal detection area 247 can be omitted as well as the remote control device. The multifunctional mobile communication device can also be a multifunctional PDA (personal digital assistant) or another mobile communication device.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multifunctional mobile communication device comprising a main body provided with a screen, at least one keypad, a main board, a TV button, a screen button, one or more ports and an antenna; wherein the main board is electronically connected with a display module, an operating module, an audio input/output module, a power module, a switching module and a TV module; the screen is controlled by the display module and is for processing and outputting video signals; the keypad is electronically connected with the operating module for controlling operation or data input; the TV button and the screen button are electronically connected with the switching module and the TV module for switching the device mode and switching the TV operating surface; the antenna and the one or more ports are both connected with the TV module for receiving and transmitting signals; the power module is used for power charging of the display module, the operating module and the audio input/output module.

2. The multifunctional mobile communication device as claimed in claim 1, wherein the display module, the operating module, the audio input/output module, the power module, the switching module, and the TV module are connected with the main board by universal serial bus.

3. The multifunctional mobile communication device as claimed in claim 1, wherein the screen is a touch panel.

4. The multifunctional mobile communication device as claimed in claim 3, wherein the keypad includes a direction key, an on-off key, and a volume key.

5. The multifunctional mobile communication device as claimed in claim 1, wherein the ports include a universal serial bus port and a cable port.

6. The multifunctional mobile communication device as claimed in claim 1, wherein the antenna is located inside the main body.

7. The multifunctional mobile communication device as claimed in claim 1, wherein the main body further comprises a TV signal detection area including a plurality of indicator lights.

8. The multifunctional mobile communication device as claimed in claim 7, wherein the main body includes a first surface and a second surface, the TV signal detection area is located at the joint of the first surface and the second surface.

9. The multifunctional mobile communication device as claimed in claim 1 further comprising a remote control device for remote controlling of the TV module.

10. The multifunctional mobile communication device as claimed in claim 1, wherein the keypad includes a direction key, an on-off key, and a volume key.

11. A multifunctional mobile communication device comprising:
a main body provided with a screen, a receiver, at least one keypad, a TV button, a screen button, one or more ports and an antenna; and
a main board installed within the main body;
an operating module electrically connecting the main board with the at least one keypad for controlling operation or data input;
an audio input/output module electrically connecting the main board with the receiver for inputting or outputting audio signal;
a TV module electrically connecting the main board with the TV button and the screen button for receiving and processing television signals; the TV module electrically connected with the antenna and the one or more ports for receiving and transmitting signals; and
a switching module electrically connecting the main board with the TV button and the screen button for switching the TV operating surface,
wherein the TV button is pressable to switch the device between a TV mode and a phone mode and the TV screen button is pressable to switch the TV playing screen into another display device.

12. The multifunctional mobile communication device as claimed in claim 1, wherein the another display device is one choosen from a group comprising a mobile phone, a computer and a notebook.

13. The multifunctional mobile communication device as claimed in claim 1, wherein the at least one keypad comprises a direction key, an on-off key, and a volume key.

14. The multifunctional mobile communication device as claimed in claim 13, wherein the screen is a touch panel.

15. The multifunctional mobile communication device as claimed in claim 14, further comprising a power module electrically connected with the main board for supplying power to the display module, the TV module, the switching module, the operating module and the audio input/output module.

16. The multifunctional mobile communication device as claimed in claim 15, wherein the screen, the receiver, the at least one keypad, the TV button, the screen button and one or more ports are disposed on an exterior surface of the main body while the operating module, the audio input/output module, the TV module, the switching module, the power module are installed within the main body.

17. The multifunctional mobile communication device as claimed in claim 11, wherein the main body further comprises a TV signal detection area comprising a plurality of indicator lights disposed on an exterior surface of the main body.
